(19) United States
(12) Patent Application Publication
(10) Pub. No.: US 2015/0097111 A1
(43) Pub. Date: Apr. 9, 2015

(54) OPTOELECTRONIC SENSOR AND METHOD FOR THE PRODUCTION OF SUCH

(71) Applicant: SICK STEGMANN GmbH, Donaueschingen (DE)

(72) Inventors: David Hopp, Donaueschingen (DE); Stefan Basler, Donaueschingen (DE); Reinhold Mutschler, Donaueschingen (DE)

(21) Appl. No.: 14/505,530

(22) Filed: Oct. 3, 2014

(30) Foreign Application Priority Data
Oct. 9, 2013 (EP) 13187973.6

(51) Int. Cl. G01D 5/347; B23K 26/38

(52) U.S. Cl. CPC G01D 5/34707; G01D 5/3473; B23K 26/383
USPC 250/231.13; 250/231.1; 427/58; 427/125; 216/24

(57) ABSTRACT

An optoelectronic sensor, in particular used for the detection of an angle of rotation, includes a dimensional scale, a light transmitter, which transmits transmission light in transmission light directions, and a light receiver having a light reception surface, which is arranged in such a way that the light reception surface is substantially located between the dimensional scale and the light receiver. The light receiver receives backwardly reflected transmission light as received light. The light receiver also includes a transmission light directing unit. The light directing unit is configured such that a predefined angle of deflection of the transmission light results with respect to the transmission light directions when the transmission light again exits from the transmission light directing unit. The transmission light directing unit is provided in the light receiver; and the transmission light directing unit is composed of at least one aperture which is incorporated into the light receiver.

The invention relates to an optoelectronic sensor in accordance with the preamble of the claim 1 and to a method for the production of such a sensor.

For the detection of an angle of rotation, e.g. of a shaft, optically working principles are used. Independent of the respective optical principle, corresponding sensors are composed of at least one light source, a dimensional scale and a receiver. The dimensional scale is rotationally fixedly connected to a shaft whose movement is to be detected and via a relative movement with respect to the receiver generates an intensity modulation of the signal at the receiver which serves as an angle signal. Two basic design variants are used: transmissive and reflexive. In particular the reflexive design in which the optical path is reflected at the dimensional scale has particular advantages, as the transmitter and the receiver can then namely be arranged at the same side, for example at the same side of an electronic card. In this way, a real decoupling of the rotary encoder and of the rotating dimensional scale is possible. Transmitter/receiver must merely only “see” the dimensional scale.

The design of a reflexive optical path represents a challenge in dependence on the optical functional principle, as the individual components, in particular the transmitter and the receiver cannot be aligned along a single optical axis and orthogonal to this. Having regard to most optical functional principles, however, a central alignment of all components is made available, in particular for reasons of symmetry.

The endeavor on the assembly of reflexive optical functional principles for rotatory angle sensors is to bring the illumination, the dimensional scale as well as the receiver centrally onto an optical axis. This requires the central placement of the light source. A central placement of the light source in turn requires a placement of the receiver outside of the optical axis. A symmetry then only results when a plurality of receivers are positioned around the light source or when the light is deflected. However, beam splitters, mirror systems or the like which have to be adjusted are required for this purpose. In such systems the individual components are arranged in different assembly planes which are not in parallel to one another. The positioning and/or the alignment of the optical components in a system having a plurality of assembly planes is demanding in effort and is cost intensive. Likewise, a deflection of the illumination optical path is complicated and is frequently associated with a considerable loss in intensity. Moreover, such an assembly requires a considerable construction space.

It is suggested by the applicant to provide the receiver coaxially between the light source and the dimensional scale as a possible compact assembly of a reflexive angle of rotation sensor, with the light from the light source being transmitted to the dimensional scale through an opening in the form of an aperture in the receiver.

Having regard to the contemplated assembly it has not been considered that the shaping of the aperture has an influence on the illumination of the light receiver.

Starting therefrom it is the object of the invention to improve an optoelectronic sensor of the initially named kind such that an improved evaluation of the sensor is enabled. Furthermore, it is an object of the invention to provide a method for the manufacture of an optoelectronic sensor which makes available a sensor with improved illumination.

This object is satisfied in accordance with the invention by an optoelectronic sensor having the features of the claim 1 and by a method for the manufacture of the same having the features of the claim 8.

The optoelectronic sensor in accordance with the invention, in particular for the detection of an angle of rotation is provided comprising a dimensional scale, a light transmitter, which transmits transmission light into transmission light directions, and a light receiver having a light reception surface, wherein the light reception surface is arranged in such a way that the light reception surface is substantially located between the dimensional scale and the light transmitter and the light receiver receives backwardly reflected transmission light as received light; and wherein a transmission light directing unit is provided which is configured in such a way that a predefined angle of deflection of the transmission light results with respect to the transmission light directions when the transmission light again exits from the transmission light directing unit, wherein the transmission light direction unit is provided in the light receiver, wherein the transmission light directing unit is composed of at least one aperture which is incorporated into the light receiver in particular by mechanical drilling, laser drilling, sand blasting or chemical etching in such a way that the transmission light directing unit preferably has a cylindrical, conically diverging shape, a conically converging shape, a bi-conical shape or an oval shape, and wherein the sidewalls of the transmission light directing unit reflecting the transmission light is preferably coated in a light reflecting manner, in particular with metallic material, in particular aluminum, titanium, copper, silver or gold and is configured as light scattering or as partly light scattering.

An essential advantage of the invention is an active influence on the beam optical path of the transmission light through a suitable design of the light passage through the light receiver by means of the light directing unit which shapes the distribution and the homogeneity of the received light at the light reception surface in such a way that the evaluation is improved.

Hereby the characteristics of the overall illumination can be changed by means of the aperture geometry in such a way that the transmission light directing unit, in particular at least the aperture acts as a beam-forming optics. Advantageously, the aperture can be configured pyramid-like at a rectangular base surface.

In accordance with a further preferred embodiment the transmission light directing unit is composed of at least one sleeve inserted into the light receiver. Hereby the sleeve can have a cylindrical shape, a conically diverging shape, a conically converging shape, a bi-conical shape or an oval shape as required. The shape of the sleeve can be configured differently on the outside and on the inside, in such a way that the sleeve can serve as an adaptation to an aperture geometry which is less favorable from a manufacturing point of view.

In particular a shutter effect of the transmission light directing unit, in particular of the aperture and/or of the sleeve, can be utilized in order to shade the transmission light in a targeted manner and/or to targetedly generate diffraction effects with respect to the transmission light.

The polarization and/or phase jumps at the coated surface arising on the reflection can targetedly be used in order to e.g. change and/or to mix a state of polarization. Additionally, a shading of the photo-sensitive light receiver surfaces at the light receiver can be achieved, whereby interference influences are avoided or can at least be reduced. Advantageously, the properties of the total reflection can be used in a targeted manner in dependence on the respective index of refraction of the utilized materials at the sidewalls of the transmission light directing unit in contrast to a mirrored coating.

In accordance with the invention the method for the manufacture of an optoelectronic sensor comprises the following steps, arranging a dimensional scale and a light transmitter, which irradiates transmission light into transmission light directions, and a light receiver having a light reception surface in such a way that the light reception surface is substantially located between the dimensional scale and the light transmitter and the light receiver receives backwardly reflected transmission light as received light; and providing a transmission light directing unit in the receiver in such a way that the transmission light experiences a predefined angle of deflection with respect to the transmission light directions when it again exits from the transmission light directing unit, wherein at least one aperture is incorporated into the light transceiver by mechanical drilling, laser drilling, sand blasting or chemical etching, as a transmission light directing unit in such a way that the sidewalls of the transmission light directing unit have a cylindrical shape, a conically diverging shape, a conical converging shape, a bi-conical shape or an oval shape. Advantageously, the aperture is configured pyramid-shaped with a rectangular base surface, in particular on etching of silicon along the lattice angles and wherein the sidewalls of the transmission light directing unit are coated with a light reflecting material, in particular aluminum, titanium, copper, silver or gold and are processed also as light scattering or as partly light scattering.

In accordance with a further embodiment a sleeve is inserted into the light receiver as a transmission light directing unit.

Furthermore, the sleeve is produced from a light reflecting material, in particular from aluminum, titanium, copper, silver or gold.

An optical element having a light refracting function, a light diffracting function and/or a light polarizing function and/or having diffractive structures for diffraction, deflection or dispersion of the transmission light can be provided in the transmission light directing unit which are provided in a recess in the light receiver and/or in the circuit board. The optical element can also be configured as an optical filter having wavelength selection for the transmission light. This has the advantage that optical lens functions and/or filter functions can be integrated into the optoelectronic sensor and in this way further separate optical components can be saved.

Advantageously, the light transmitter is configured as an LED or as a laser diode. The light receiver can be configured in a CCD manner of construction or in a CMOS manner of construction or as a cluster of photo diodes at a semiconductor chip.

Particularly, advantageously the invention can be used in angle of rotation sensors which determine the angle of rotation in accordance with the polarization optical principle and in which the optical path is configured reflexive. For this purpose, the rotary encoder has a polarizer which rotates relative to the light source and which forms a dimensional scale. The transmission light is reflected at the polarizer and passes through one or more linearly polarizing analyzers which are respectively arranged in front of the reception elements. The receiver has at least two reception regions that can be evaluated separately and that are associated with the analyzers, wherein the directions of polarization of the analyzers are displaced with respect to one another at an angle. The receiver is preferably configured as a light reception array. Through the evaluation of the signals received by the two reception regions, an angle of rotation and a direction of rotation can be incrementally determined.

In order to achieve an unambiguousness over 360° the polarizer can be configured as a disc having a normal, wherein the normal forms angles with respect to the axis of rotation different from zero.

In the following the invention will be explained in detail by means of embodiments with reference to the drawing. In the drawing there is shown:

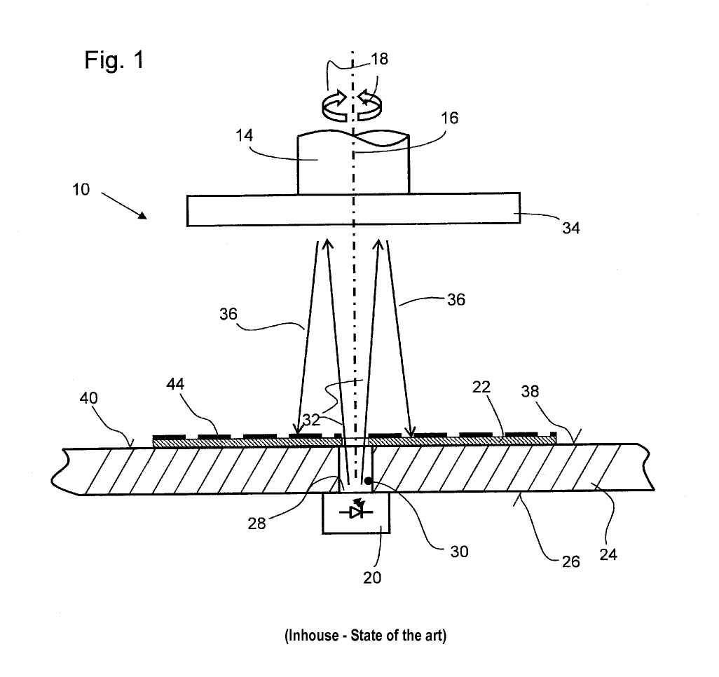

FIG. 1 a schematic illustration of an intended optoelectronic sensor;

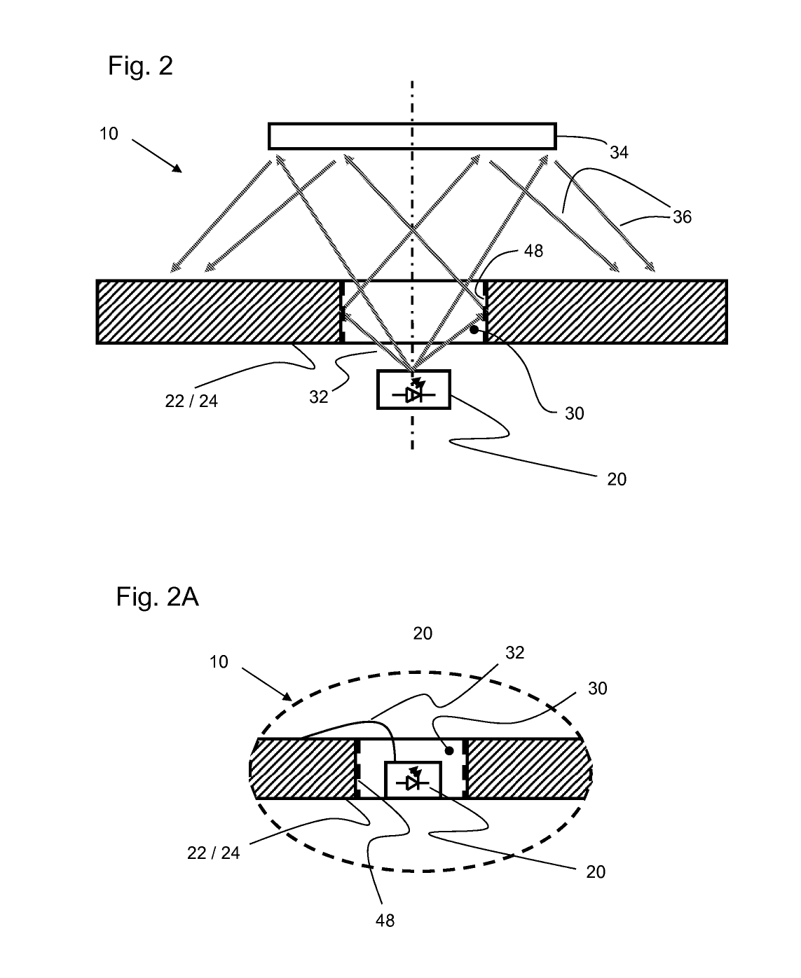

FIGS. 2-2A a schematic illustration of an embodiment in accordance with the invention of the optoelectronic sensor having a transmission light directing unit;

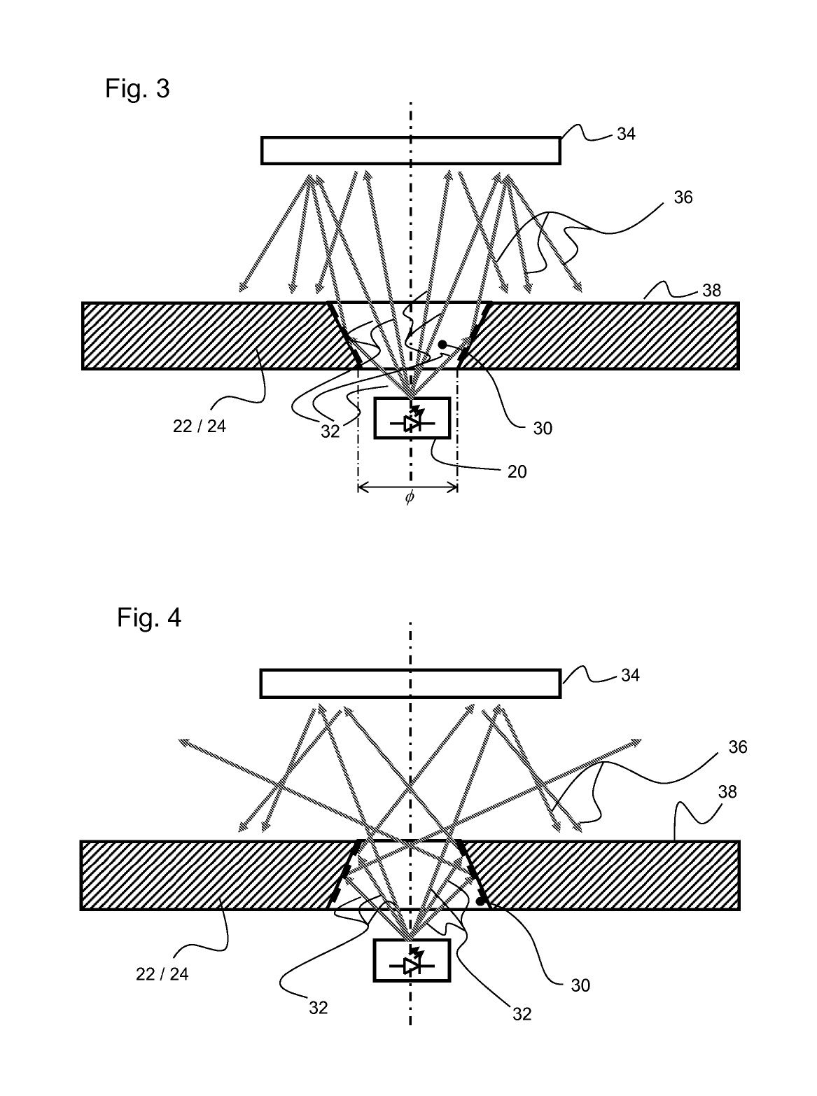

FIGS. 3-6 an embodiment of the transmission light directing unit in accordance with the invention;

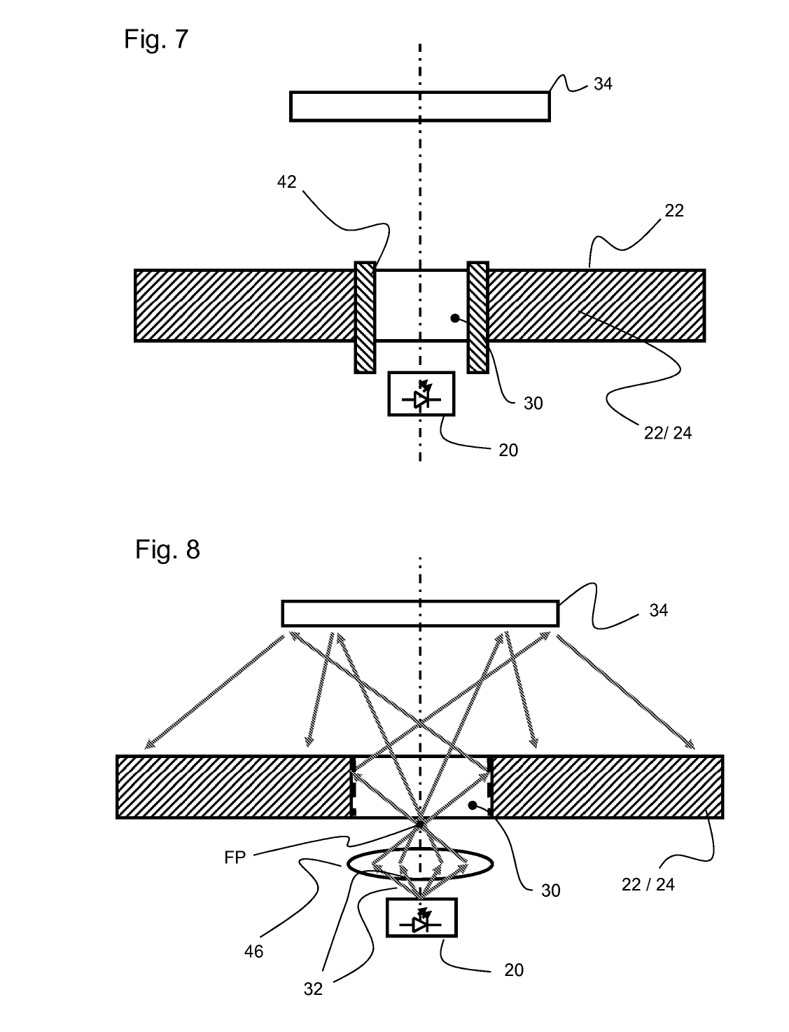

FIG. 7 a further embodiment in accordance with the invention of the transmission light directing unit as a sleeve; and

FIG. 8 a further embodiment with the use of an additional beam forming element.

An optoelectronic sensor 10 envisaged by the applicant is shown in FIG. 1 which serves for the detection of an angle of rotation of a shaft 14 which rotates about an axis of rotation 16 in the illustrated arrow directions 18. The sensor 10 is rotationally fixedly arranged and can determine the rotation of the shaft 14 in accordance with the optical principle in this embodiment.

With reference to the example the functional principle of the optoelectronic sensor 10, in particular of a rotary encoder is described which determines the angle of rotation in accordance with the principle of polarization, this means through the detection of a direction of polarization.

A transmission light 32 of a light transmitter 20, which in the case of an LED is non-polarized, is irradiated in a spherical manner slightly diverging and is incident at a dimensional scale 34 rotating with the shaft 14, with the dimensional scale being configured as a linear polarizer in this instance. The light reflected by the dimensional scale 34 and/or the polarizer (received light 36) then has a linear polarization whose direction corresponds to the current angle of rotation of the shaft 14. The received light 36 passes through an analyzer and/or a photosensitive detector 44 which is nothing other than a linear polarizer and is detected by a reception region of a light receiver 22 arranged beneath the analyzer 44. Advantageously, the light receiver 22 is configured as a receiver array or the like, wherein an analyzer 44 is arranged in front of each reception element and the analyzers 44 have different directions of polarization. The intensity of the light measured by the reception elements has a cos² dependency with respect to the angle of rotation. The relative angle of rotation as well as the direction of rotation can be determined in a manner known per se through the cos² signals of the reception elements which are arranged behind the analyzers whose direction of polarizations have an angular shift with respect to one another.

The sensor 10 thus has a light transmitter 20 and the light receiver 22. Light transmitter 20 and light receiver 22 are symmetrically arranged which for this assembly means that they lie symmetrical with respect to the axis of rotation 16 and their respective optical axes coincide with the axis of rotation 16.

The light transmitter 20 is arranged and received at a rear side 26 of an electronic card 24 which simultaneously is configured as a circuit carrier for the light receiver 22 and indeed in such a manner that the light irradiating surface 28 of the light transmitter 20 is aligned with respect to the rear side 26. So that the light can then also exit from the light transmitter 20, the electronic card 24 has an aperture 30 which is aligned with the light irradiating surface 28 and thus can irradiate transmission light 32 along the optical axis 16 in the direction towards the dimensional scale 34.

The transmission light 32 is reflected by the dimensional scale 34 and is incident as received light 36 at a light reception surface 38 of the light receiver 22. The light reception surface 38 is disposed facing the dimensional scale 34, wherein the optical axis of the light receiver 22 lies coaxial with respect to the optical axis of the light transmitter 20. The light receiver 22 is preferably configured as an arrangement of a plurality of photo diodes and particularly preferably as a light receiver array having a plurality of reception elements in a CCD manner of constructions or a CMOS manner of construction.

Thus, an arrangement is created in which the transmission light 32 is irradiated into transmission light directions which irradiate from the light transmitter 20 through the light reception surface 38 into the direction towards the dimensional scale 34 and thus the light transmitter 20 and the light receiver 22 to a certain degree “look in the same direction”. The transmission light 32 of the light transmitter 20 arranged on the side of the light receiver 22 disposed remote from the light reception surface 38 in this respect centrally passes through the light receiver 22 in such a way that the received light 36 which has arisen due to reflection at the dimensional scale 34 can be incident around the aperture 30 at the light reception surface 38 and can thus be detected by the light receiver 22.

The electronic card 24 can have further non-illustrated electronic components, e.g. for the control of the light transmitter 20 and/or for the evaluation of the signals of the light receiver 22 and/or for the processing of these signals and for the output of output signals, e.g. in the form of angular values.

The light transmitter 20 can be an LED or an LED chip, a laser diode or a laser chip.

FIG. 2 shows a schematic assembly of a sensor 10 in accordance with the invention in which a transmission light directing unit, in particular in the form of a cylindrical aperture 30, is provided in the light receiver 22. The transmission light directing unit is incorporated by mechanical drilling, laser drilling, sand blasting or chemical etching in such a way that it is arranged coaxially between the light transmitter 20 and the dimensional scale 34.

The transmission light 32 is transmitted by the light receiver 20 in the direction of the transmission light directing unit in such a way that the transmission light 32 is reflected at a predefined angle in the transmission light directing unit whose sidewalls have been coated in a light reflecting manner, in particular with a metallic material 40, in particular aluminum, titanium, copper, silver or gold and again exits from the transmission light directing unit at a therefrom resulting desired angle of exit and/or is incident at the dimensional sale 34 at a therefrom resulting desired angle of incidence.

Correspondingly, the transmission light 32 is reflected backwardly as received light 36 from the dimensional scale 34 at the defined angle onto the light reception surface 38, where the received light 36 is evaluated with all parameters, such as e.g. light intensity and angle of polarization.

Thereby a predefined optical path can be achieved which enables an improved evaluation.

Advantageously, the light receiver 22 and the electronic card 24 are configured as a monolithic element in such a way that a very compact assembly additionally results.

FIG. 2A shows an embodiment in accordance with the invention having an integrated arrangement of the light transmitter 20 in the transmission light directing unit, wherein the sidewalls are coated in a light reflecting manner with a metallic material 48.

Hereby the light transmitter 20 is arranged within the aperture 30 of the light receiver 22 in such a way that the axial construction size of the sensor 10 can be further reduced. An electronic contacting takes place via a bonding wire 32 which in the illustrated embodiment is directly bonded and/or electrically connected to the light receiver 22.

Having regard to this arrangement, the light transmitter 20 is not partly covered by the light receiver 22 in such a way that the complete light strength of the light transmitter 20 can be made available for the measurement.

In accordance with the FIG. 3 the transmission light directing unit is configured in the form of a conically diverging hole 30 in such a way that the transmission light directing unit acts in a manner similar to a collection lens. Hereby, an internal diameter φ of the transmission light directing unit, in particular of the aperture 30, increases from the light transmitter 20 in the direction of the dimensional scale 34. Thereby a sum of the angles of radiation of the transmission light 32 are smaller on an exit from the transmission light directing unit than on an entry into the same. Thus, the transmission light 32 is generally bunched in the direction with respect to the optical axis, whereby a significantly stronger light intensity can be achieved. The reduced angle of radiation is correspondingly reflected from the dimensional scale 34 onto the light reception surface 38 in such a way that a bunching of the received light 36 at the light reception surface 38 leads to an improved evaluation with an increased intensity of the signal.

In contrast to the previously described embodiment also a scattering can expediently be desired instead of a focusing of the angle of the beam in such a way that in accordance with FIG. 4 a conically converging transmission light directing unit is provided in the light receiver 22. The internal diameter of the transmission light directing unit hereby reduces from the light transmitter 20 in the direction of the dimensional scale 34, so that the light beam of the transmission light 32 is reflected away from the optical axis. Indeed the illumination strength of the light receiver is reduced in this embodiment, however, a larger region of the light receiver can be illuminated which is advantageous in some applications.

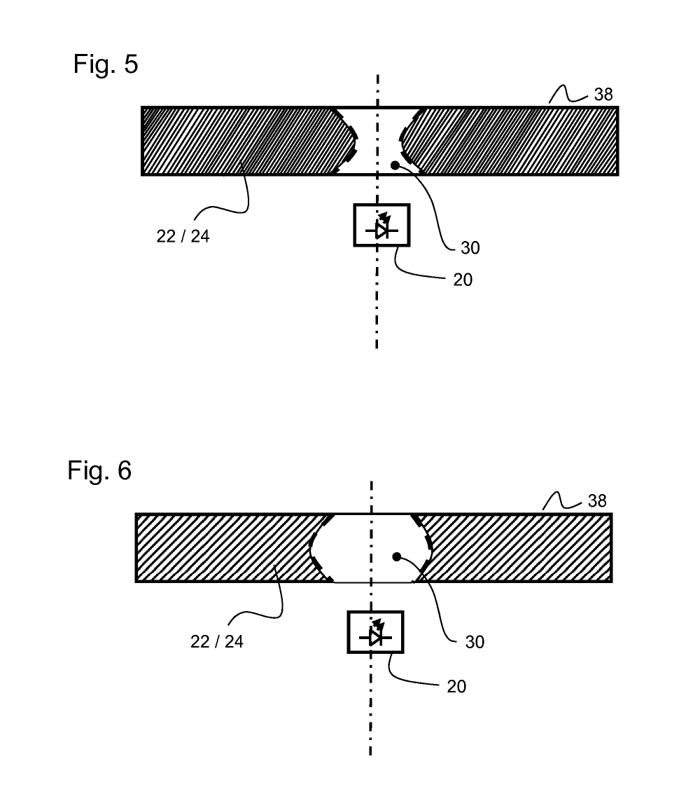

In the FIGS. 5 and 6 the transmission light directing unit is respectively configured as a bi-conical or oval aperture 30. From this a predefined expedient angle of deflection and/or angle of radiation result(s) which is/are correspondingly suitable for a case of application of this sensor 10.

Advantageously, the sidewalls of the transmission light directing unit, in particular of the aperture 30, are processed in a coated manner with light reflecting material, in particular metallic material, such as aluminum, titanium, copper, silver, gold or the like in such a way that the side surfaces represent light guides from an optical point of view, as transmission light 32 incident from a side into the aperture 30 is reflected for so long at a predefined angle of deflection until it again exits at the other end of the aperture 30. Depending on the geometry of the transmission light directing unit the characteristics of the overall illumination can in this connection be changed. The transmission light directing unit and/or the aperture 30 in this connection themselves represent a beam-forming optics. In particular cases, it can thus be achieved that a part of the transmission light 32 does not again exit from the other side of the transmission light directing unit.

In cases in which the manufacture of the defined aperture 30 in the electronic card 24 and/or in the light receiver 22, as a transmission light directing unit, is found to be too demanding in effort and cost, it is expedient to use a sleeve 42 as a transmission light directing unit, as is shown in FIG. 7. Hereby, the sleeve 42 has a defined purpose bound shape which in particular has cylindrical sidewalls, conically diverging sidewalls, conically converging sidewalls, bi-conical sidewalls or oval sidewalls. The sidewalls are preferably coated with a light reflecting material, in particular aluminum, titanium, copper, silver, gold or the like. The sleeve 42 can generally be completely composed of the aforementioned materials in such a way that the manufacture of the sensor 10 in accordance with the invention can be simplified through the insertion of the sleeve 42 into the electronic card 24 and/or into the light receiver 22.

The sidewalls of the transmission light directing unit can be machined as light scattering or as partly light scattering in such a way that no pure mirroring characteristics is achieved in order to enable e.g. a homogenization of the transmission light 32, in particular of the illumination of the sensor 10.

In FIG. 8 a further embodiment of the sensor 10 is shown in which a beam forming element 44, in particular in the form of a lens or of a diffractive element is arranged between the light transmitter 20 and the transmission light directing unit. The beam forming element 44 is arranged in such a way that a focal point FP of the transmission light 32 is directly formed in front of the entrance of the transmission light directing unit, ideally in the entrance of the same, in such a way that an exact evaluation is simplified and/or enabled by means of the known optical parameters, such as e.g. the spacings between the individual components, the focal length of the beam forming element and the like.

Advantageously, a plurality of transmission light directing units and associated light transmitters 20 can be provided at an electronic card 24 having an integrated light receiver 22. The units and light transmitter 20 are arranged in a predefined pattern and/or a grid at the electronic card 24 having an integrated light receiver 22.

During the manufacture of the optoelectronic sensor thus a dimensional scale 34, a light transmitter 20, which irradiates the transmission light in transmission light directions, and a light receiver 22 having a light reception surface 38 are arranged in such a way that the light reception surface 38 is substantially located between the dimensional scale 34 and the light transmitter 20 and such that the light receiver 22 receives backwardly reflected transmission light 32 as received light 36 and a transmission light directing unit is provided in the receiver 22 in such a way that the transmission light 32 experiences a predefined angle of deflection with respect to the transmission light directions when it again exits from the transmission light directing unit.

In this respect, an aperture 30 is mechanically drilled, laser drilled, sand blasted or chemically etched into the light receiver 22 as a transmission light directing unit. If the desired features of the exiting deflected transmission light 32 cannot be achieved by means of the aperture 30 in the light receiver 22 and/or in the electronic card 24 having an integrated light receiver 22, a sleeve 42 can be inserted into the light receiver 22 as a transmission light directing unit, the sleeve being correspondingly shaped in order to achieve the desired deflection of the transmission light 32. Hereby, the sleeve 42 can in particular be produced from a light reflecting material, such as e.g. aluminum, titanium, copper, silver, gold or the like or from a light scattering material.

### LIST OF REFERENCE NUMERALS

10 optoelectronic sensor
14 shaft
16 axis of rotation
18 direction of rotation
20 light transmitter
22 light receiver
24 electronic card
26 rear side
30 aperture
32 transmission light
34 dimensional scale
36 received light
38 light reception surface
40 upper side
42 sleeve
44 analyzer and/or photosensitive detector
46 beam forming element
48 light reflecting material
FP focal point

What is claimed is:

1. An optoelectronic sensor, comprising a dimensional scale, a light transmitter which irradiates transmission light into transmission light directions, a light receiver having a light reception surface which is arranged in such a way that the light reception surface is substantially located between the dimensional scale and the light transmitter and the light receiver receives backwardly reflected transmission light as received light, further comprising a transmission light directing unit which is configured in such a way that a predefined angle of deflection of the transmission light with respect to the transmission light directions results when the transmission light again exits from the transmission light directing unit, wherein the transmission light directing unit is provided in the light receiver, and wherein the transmission light directing unit is composed of at least one aperture which is incorporated into the light receiver, in such a way that the transmission light directing unit has a cylindrical shape, a conically diverging shape, a conically converging shape, a bi-conical shape or an oval shape and with sidewalls of the transmission light directing unit being coated in a light reflecting manner and being configured as light scattering or as partly light scattering.

2. The optoelectronic sensor in accordance with claim 1, wherein the optoelectronic sensor is provided for the detection of an angle of rotation.

3. The optoelectronic sensor in accordance with claim 1, wherein the at least one aperture is incorporated into the light receiver by mechanical drilling, laser drilling, sand blasting or chemical etching.

4. The optoelectronic sensor in accordance with claim 1, wherein the transmission light directing unit is coated in a light reflecting manner with metallic material.

5. The optoelectronic sensor in accordance with claim 4, wherein the metallic material is one of aluminum, titanium, copper, silver and gold.

6. The optoelectronic sensor in accordance with claim 1, wherein the aperture is configured as pyramid-shaped with a rectangular base surface.

7. The optoelectronic sensor in accordance with claim 1, wherein the transmission light directing unit is composed of at least one sleeve inserted into the light receiver.

8. A method for the production of an optoelectronic sensor comprising the steps of:
arranging a dimensional scale and a light transmitter which irradiates transmission light into transmission light directions and a light receiver having a light reception surface in such a way that the light reception surface is substantially located between the dimensional scale and the light transmitter and the light receiver receives backwardly reflected transmission light as received light; and
providing a transmission light directing unit in the light receiver in such a way that the transmission light experiences a predefined angle of deflection with respect to the transmission light directions when it again exits from the transmission light directing unit;
wherein at least one aperture is mechanically drilled, laser drilled, sand blasted or chemically etched in the light receiver as a transmission light directing unit such that sidewalls of the transmission light directing unit have a cylindrical shape, a conically diverging shape, a conically converging shape, a bi-conical shape or an oval shape;
coating the sidewalls of the transmission light directing unit with a light reflecting material; and
wherein the sidewalls of the transmission light directing unit are configured as light scattering or as partly light scattering.

9. The method in accordance with claim 8, wherein the reflecting material is one of aluminum, titanium, copper, silver and gold.

10. The method in accordance with claim 8, wherein the aperture is produced as pyramid-shaped with a rectangular base surface.

11. The method in accordance with claim 10, wherein the aperture is produced by etching of silicon along the lattice angles.

12. The method in accordance with claim 8, wherein a sleeve is inserted as a transmission light directing unit into the light receiver.

13. The method in accordance with claim 12, wherein the sleeve is produced from a light reflecting material.

14. The method in accordance with claim 13, wherein the light reflecting material is one of aluminum, titanium, copper, silver and gold.
